(19) United States
(12) Patent Application Publication
(10) Pub. No.: US 2006/0258203 A1
(43) Pub. Date: Nov. 16, 2006

(54) Card Connector

(76) Inventors: Satoru (Jack) Watanabe, Kanagawa (JP); Eason Liu, Taipei (TW)

Correspondence Address: BARLEY SNYDER, LLC, 1000 WESTLAKES DRIVE, SUITE 275, BERWYN, PA, 19312, US

(21) Appl. No.: 11/383,010

(22) Filed: May 12, 2006

(30) Foreign Application Priority Data
May 12, 2005 (TW) 94207644

(51) Int. Cl. H01R 13/00

(52) U.S. Cl. 439/485

(57) ABSTRACT

A card connector comprises a card insertion opening for receiving a PC card. A heat-dissipating device moves between a heat-dissipating position and a non-heat-dissipating position. The heat-dissipating device is positioned for contact with the PC card in the heat-dissipating position. A stopper is arranged adjacent to the card insertion opening. The stopper at least partially blocks the card insertion opening when the heat dissipating device is in the heat-dissipating position.

### FIELD OF THE INVENTION

The invention relates to a card connector having a heat-dissipating device, and more particularly to a card connector that has a movable cover that prevents the insertion of a personal computer (PC) card when the heat-dissipating device is in a closed or heat-dissipating position.

### BACKGROUND OF THE INVENTION

A Personal Computer Memory Card International Association (PCMCIA) is a memory card standard for an interface between a computer and a computer peripheral apparatus. A PCMCIA card or PC card is an integrated circuit (IC) card that conforms to the PCMCIA standard, and a PCMCIA slot is a slot that conforms to the PCMCIA standard. The PC cards are widely used for connecting computers with computer peripheral apparatuses. For example, PC cards are an optimal interface for notebook computers, which use external peripheral apparatuses due to their small size. Presently, the PC card acts as a data transmitting or local network card for the notebook computer, in order to eliminate the need for a user to carry heavy peripheral apparatuses.

When the PC card is inserted into a card connector, a heat-dissipating device is lowered down into a closed or heat-dissipating position. In the closed or heat-dissipating position, a thermal interface material (TIM) adhered to a bottom of the heat-dissipating device contacts the PC card. As a result, heat is dissipated from the PC card via heat conduction. In order to extract the PC card from the card connector, the heat-dissipating device must first be moved away from the closed or heat-dissipating position upward into an open or non-heat-dissipating position. The PC card may then be extracted from the card connector by the user.

If the user compulsively extracts the PC card, however, when the heat-dissipating device is still in the closed or heat-dissipating position and then either inserts the same or another PC card into the card connector, because the heat-dissipating device is still in closed or heat-dissipating position, the PC card will contact the TIM on the bottom of the heat-dissipating device. This could cause the TIM to separate from the bottom of the heat-dissipating device, which will negatively impact the performance of the heat-dissipating device. These conventional card connectors are therefore disadvantageous and further improvements thereto are desirable.

### BRIEF SUMMARY OF THE INVENTION

The invention provides a card connector comprising a card insertion opening for receiving a PC card. A heat-dissipating device moves between a heat-dissipating position and a non-heat-dissipating position. The heat-dissipating device is positioned for contact with the PC card in the heat-dissipating position. A stopper is arranged adjacent to the card insertion opening. The stopper at least partially blocks the card insertion opening when the heat dissipating device is in the heat-dissipating position.

### BRIEF DESCRIPTION OF THE DRAWINGS

FIG. 1 is a front view of a card connector according to the invention showing the card connector in an open or non-heat-dissipating position.

FIG. 2 is a side view of the card connector shown in FIG. 1.

FIG. 3 is a top view of the card connector shown in FIG. 1.

FIG. 4 is a perspective exploded view of a movable cover of the card connector shown in FIG. 1.

FIG. 5 is a front view of the card connector shown in FIG. 1 shown with a PC card inserted therein.

FIG. 6 is a front view of the card connector according to the invention showing the card connector in a closed or heat-dissipating position.

FIG. 7 is a side view of the card connector of FIG. 6.

FIG. 8 is a top view of the card connector of FIG. 6.

### DETAILED DESCRIPTION OF THE INVENTION

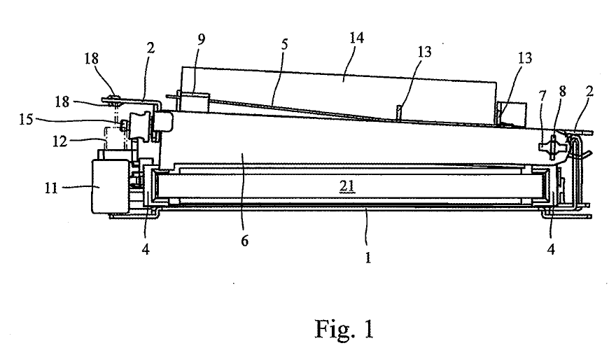

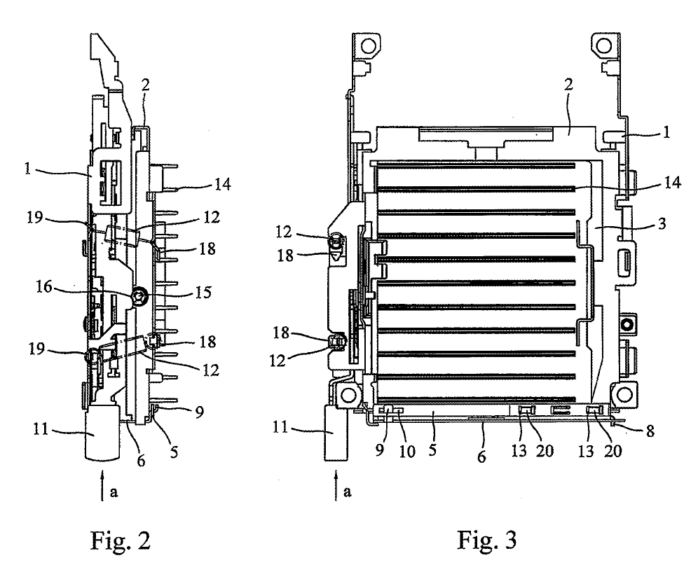

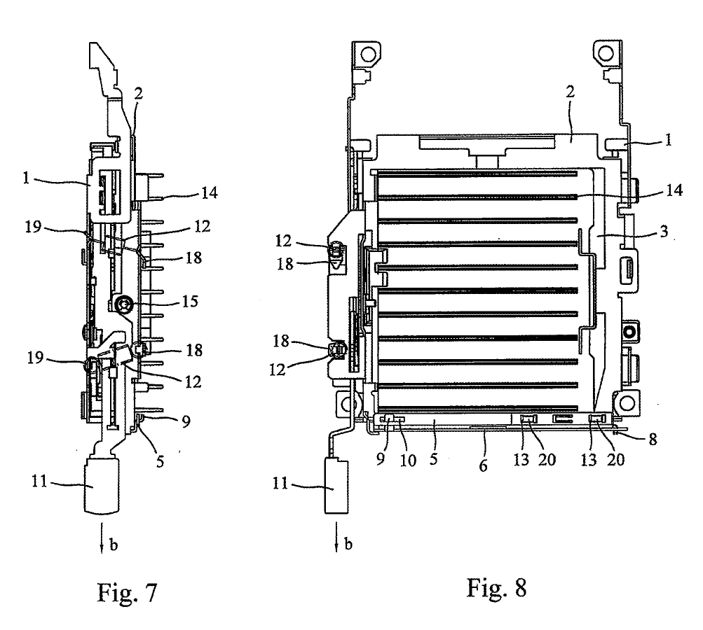

FIG. 1 shows a card connector according to the invention. As shown in FIG. 1, the card connector comprises a bottom plate 1 connected to a support frame 2. As shown in FIG. 3, a heat-dissipating device 3 is connected to the support frame 2. Guide members 4 are arranged between the bottom plate 1 and the heat-dissipating device 3 such that the bottom plate 1, the support frame 2, and the guide members 4 form a card insertion opening 21, as shown in FIG. 1. 014 A lever 11 is provided on a side of the guide members 4 and connects the bottom plate 1 to the guide members 4. The lever 11 includes a shaft receiving recess 16. The lever 11 can be pushed in a first direction indicated by arrow a in FIGS. 2-3 and can be pulled in a second direction indicated by arrow b in FIGS. 7-8.

As shown in FIG. 2, a shaft 15 projects outward from a side of the support frame 2. A support frame fastening member 18 is provided on a side of the support frame 2. A bottom plate fastening member 19 is provided on the bottom plate 1. The support frame fastening member 18 is connected to the bottom plate fastening member 19 by springs 12 extending there between such that the support frame 2 can move upward or downward with respect to the bottom plate 1 in accordance with movement of the lever 11 in the first direction and/or the second direction due to the engagement of the shaft 15 in the shaft receiving recess 16.

As shown in FIGS. 1-2, a movable cover comprises a leaf spring 5 and a stopper 6. The leaf spring 5 extends substantially parallel to the support frame 2. As shown in FIG. 3, a first end of the leaf spring 5 is provided with holding members 20. The holding members 20 consist, for example, of substantially T-shaped apertures. Retainers 13 extending from the support frame 2 pass through a wider portion of the substantially T-shaped apertures and are finally positioned in a narrower portion of the substantially T-shaped apertures. Because the holding members 20 provided on a first end of the leaf spring 5 engage with the retainers 13 of the support frame 2, the leaf spring 5 is resilient with respective to the second end of the holding members 20.

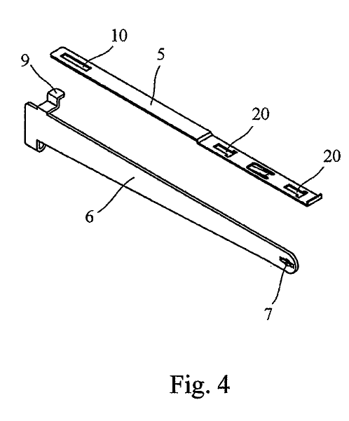

The stopper 6 is provided on a front of the support frame 2 and extends substantially perpendicularly to the leaf spring 5. As shown in FIGS. 3-4, a tab 9 extends from a first side of the stopper 6 and passes through a tab receiving aperture 10 on a second end of the leaf spring 5. As shown in FIG. 3, a projection 8 extends from the support frame 2 and passes through a projection receiving aperture 7 on a second side of the stopper 6 such that the stopper 6 is pivotally connected thereto. Because the tab 9 of the stopper 6 passes through the tab receiving aperture 10 on the second end of the leaf spring 5 and the projection receiving aperture 7 on the second side of the stopper 6 pivotally connects with the projection 8 of the support frame 2, the stopper 6 can resiliently rotate around the projection receiving aperture 7.

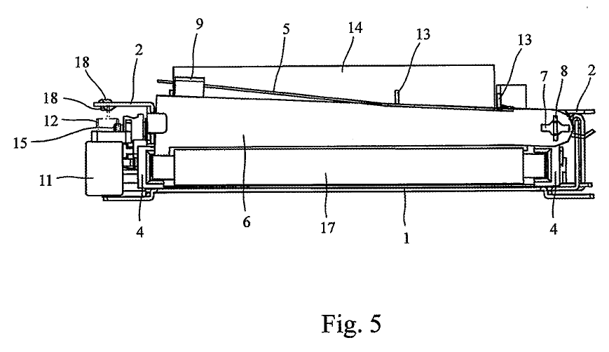

A terminal set (not shown) is provided on an opposite side of the movable cover and connects the card connector to another electrical device (not shown) to achieve an electrical connection between, for example, a PC card 17 (FIG. 5) and the electrical device (not shown).

As shown in FIG. 3, the heat-dissipating device 3 includes a plurality of substantially parallel heat-dissipating fins 14. A thermal interface material (TIM) (not shown) is provided on the bottom of the heat-dissipating device 3. The heat-dissipating device moves from an open or non-heat dissipating position to a closed or heat-dissipating position, as a result of the upward and downward movement of the support frame 2.

The method for inserting the PC card 17 and extracting the PC card 17 from the card connector equipped with the heat-dissipating device 3 will now be described. As shown in FIG. 5, the PC card 17 is inserted into the card receiving opening 21 when the heat-dissipating device 3 is in the open or non-heat-dissipating position. As the PC card 17 is inserted into the card connector through the guide members 4, the heat-dissipating device 3 is lowered downward into a closed or heat-dissipating position so that the thermal interface material (TIM) (not shown) on the bottom of the heat-dissipating device 3 will contact the PC card 17 and thereby deliver heat for the purpose of heat dissipation. The stopper 6 will contact an upper edge of the PC card 17 and thus rotate clockwise to thereby elastically move the leaf spring 5 upward.

To return the heat-dissipating device 3 to the open position, the lever 11 is pressed in the first direction shown by the arrows a in FIGS. 2-3. When the lever 11 is moved in the direction of the arrows a shown in FIGS. 2-3, the shaft 15 of the support frame 2 is received in the shaft receiving recess 16 of the lever 11, such that the heat-dissipating device 3 will move upwards into an open or non-heat-dissipating position. The PC card 17 is then extracted from the card receiving opening 21 by a user.

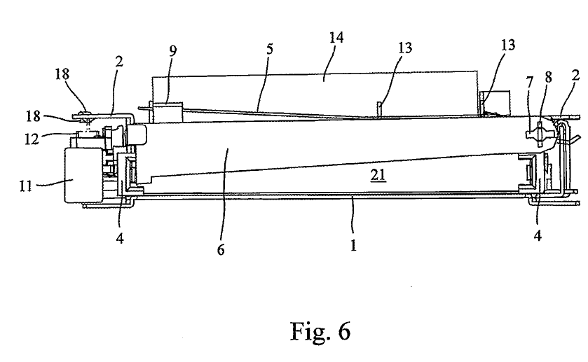

If the user tries to extract the PC card 17 from the card receiving opening 21 when the heat-dissipating device 3 is in the closed or heat-dissipating position, as shown in FIGS. 6-8, the stopper 6 will make an elastic rotation counterclockwise due to the elastic force exerted on it by the leaf spring 5, such that the stopper 6 will at least partially obstruct the card insertion opening 21 thereby preventing either the extraction of the PC card 17 or the insertion of another PC card. If the user wants to re-insert the PC card 17 or another PC card, the lever 11 needs to be pressed in the direction of the arrow a shown in FIGS. 2-3 such that the heat-dissipating device 3 will move upwards to the open or non-heat-dissipating position, thereby enabling insertion of the PC card 17 therein.

The foregoing illustrates some of the possibilities for practicing the invention. Many other embodiments are possible within the scope and spirit of the invention. It is, therefore, intended that the foregoing description be regarded as illustrative rather than limiting, and that the scope of the invention is given by the appended claims together with their full range of equivalents.

What is claimed is:

1. A card connector, comprising:
a card insertion opening for receiving a PC card;
a heat-dissipating device moveable between a heat-dissipating position and a non-heat-dissipating position, the heat-dissipating device being positioned for contact with the PC card in the heat-dissipating position; and
a stopper arranged adjacent to the card insertion opening, the stopper at least partially blocking the card insertion opening when the heat dissipating device is in the heat-dissipating position.

2. The card connector of claim 1, further comprising a lever that moves the heat-dissipating device between the heat-dissipating position and the non-heat-dissipating position.

3. The card connector of claim 1, wherein the stopper is mounted on a leaf spring, the leaf spring applying a force to the stopper when the heat dissipating device is in the heat-dissipating position to move the stopper into the card insertion opening.

4. The card connector of claim 1, wherein the heat dissipating device is mounted on a support frame, the support frame being connected to a bottom plate and moveable relative thereto, the support frame being positioned closer to the bottom plate when the heat-dissipating device is in the heat-dissipating position.

5. The card connector of claim 4, further comprising a leaf spring, a first end of the leaf spring being mounted on the support frame and a second end of the leaf spring being mounted to a first end of the stopper, the leaf spring applying a force to the stopper when the heat dissipating device is in the heat-dissipating position to move the stopper into the card insertion opening.

6. The card connector of claim 5, wherein a second end of the stopper is pivotally connected to the support frame.

7. The card connector of claim 4, further comprising a lever that moves the support frame relative to the bottom plate.

8. The card connector of claim 7, further comprising at least one spring extending between the bottom plate and the support frame for facilitating the movement of the support frame.

9. The card connector of claim 8, wherein a shaft extends from the support frame, the shaft being received in a shaft receiving recess on the lever to facilitate the movement of the support frame.

10. The card connector of claim 4, further comprising guide members arranged between the bottom plate and the heat dissipating device, the guide members, the bottom plate and the support frame forming the card insertion opening.

11. The card connector of claim 4, wherein the leaf spring extends substantially parallel to the bottom plate.

12. The card connector of claim 4, wherein the stopper extends substantially perpendicular to the bottom plate.
